(19) United States
(12) Patent Application Publication
(10) Pub. No.: US 2011/0034098 A1
(43) Pub. Date: Feb. 10, 2011

(54) YARNS, FIBERS OR FILAMENTS AND ARTICLES SHAPED THEREFROM

(76) Inventors: Franck Bouquerel, Lyon (FR); Caroll Vergelati, Sainte Baudille de la Tour (FR); Florence clement, Yzeron (FR)

Correspondence Address: BUCHANAN, INGERSOLL & ROONEY PC, POST OFFICE BOX 1404, ALEXANDRIA, VA, 22313-1404, US

(21) Appl. No.: 12/738,118

(22) PCT Filed: Oct. 10, 2008
(86) PCT No.: PCT/EP08/63600

§ 371 Date: Jul. 13, 2010

(30) Foreign Application Priority Data
Oct. 16, 2007 (FR) 0707229

(51) Int. Cl. C08L 61/10; A63B 29/02; D07B 1/00; D03D 15/00; B32B 27/02; D01D 5/10; C08L 77/00; D21G 9/00

(52) U.S. Cl. 442/181; 428/221; 264/176.1; 428/394; 525/480; 525/429; 525/132; 162/289

(57) ABSTRACT

Yarns, fibers or filaments, in particular based on polyamides, are shaped into a variety of articles, especially ropes and more particularly climbing ropes which have good mechanical properties, especially under both low and relatively high humidity conditions.

The present invention relates to yarns, fibres or filaments, in particular based on polyamide, which can especially be used for producing ropes. It relates more particularly to climbing ropes comprising these yarns, fibres or filaments, which have good mechanical properties, especially under relatively high moisture conditions.

The properties that spun articles must have differ depending on their use. Among these properties, mention may be made, for example, of tenacity, elongation at break, fatigue resistance, transparency, sheen, whiteness, dyeability, shrinkage, water retention capacity, flame retardancy, heat resistance and stability. One property that may be required, especially for applications in the “technical yarn” field, is the tensile strength, and also the damping capacity during an impact.

This is the case, for example, for ropes, cables and lines that are used in many fields, such as the maritime field, the climbing field, etc. They can, for example, be used to moor boats and ships, for example pleasure craft.

These ropes, cables and lines are subjected to high mechanical stresses when they are used, for example due to the movements of the sea, to the handling operations carried out on the rope by users, etc. In the field of climbing ropes, for example, the rope must not only withstand possible falls by the climber, but it must also dampen these falls, especially during the phase of sudden tension on the rope, in order to protect the climber from injuries resulting from the fall. There are standards that evaluate these properties, in particular the EN 892 standard. The measurement of the strength properties for the EN 892 standard is based, in particular, on the number of falls before breakage, which must be above a minimum value. The minimum requirement in terms of number of falls before breakage of the standard may be 4 or more; it depends, in particular, on the nature of the rope and on its use (single rope, double rope).

Today, climbing ropes produced from polyamide 6 yarns meet these standards. However, the conditions for measuring these standards are standard air humidity (65±5%) and temperature (25° C.) conditions. Yet the ropes may be used under very variable humidity conditions, ranging, for example, from very dry conditions (such as 30% relative humidity), for example in the desert, to very wet conditions (such as 90% relative humidity), for example after a period of heavy rain. It has been shown that some ropes known in the field of climbing that are made of polyamide 6 only have a number of falls before breakage of 2 or 3 when they have previously been soaked in water for one hour, whereas this number of falls before breakage is 10 under standard humidity (65±5%) and temperature (25° C.) conditions.

It is therefore sought to improve the tensile strength properties, and in particular the damping capacity during an impact, of ropes, especially climbing ropes, most particularly under wet conditions.

For this purpose the invention provides, as a first subject, yarns, fibres or filaments based on a thermoplastic polymer that are obtained from a composition comprising:

a thermoplastic polymer matrix; and

a novolac resin.

As a second subject, the invention provides a process for preparing these yarns, fibres or filaments.

As a third subject, the invention provides an article comprising the yarns, fibres and/or filaments of the invention, in particular climbing ropes.

As a fourth subject, the invention provides the use of the article under high humidity conditions.

Finally, as a fifth subject, the invention provides the use of a novolac resin in the field of climbing ropes.

The invention therefore relates, as a first subject, to yarns, fibres or filaments based on a thermoplastic polymer that are obtained from a composition comprising:

a polymer matrix; and

a novolac resin.

The yarns, fibres or filaments of the invention are based on a thermoplastic polymer. By way of example, mention may be made, as a suitable thermoplastic (co)polymer within the context of the invention, of: polyolefins, polyesters, polyalkylene oxides, polyoxyalkylenes, polyhaloalkylenes, poly(alkylene phthalate or terephthalate), poly(phenyl or phenylene), poly(phenylene oxide or sulphide), polyvinyl acetates, polyvinyl alcohols, polyvinyl halides, polyvinylidene halides, polyvinyl nitriles, polyamides, polyimides, polycarbonates, acrylic or methacrylic acid polymers, polyacrylates or polymethacrylates, natural polymers such as cellulose and derivatives thereof, synthetic polymers such as synthetic elastomers, or thermoplastic copolymers comprising at least one monomer identical to any of the monomers included in the aforementioned polymers and also blends and/or alloys of all these (co)polymers.

As other preferred thermoplastic polymers of the invention, mention may be made of semi-crystalline or amorphous polyamides, such as aliphatic polyamides, semi-aromatic polyamides and more generally, linear polyamides obtained by polycondensation between a saturated aliphatic or aromatic diacid and a saturated aliphatic or aromatic primary diamine, polyamides obtained by condensation of a lactam or of an amino acid, or linear polyamides obtained by condensation of a mixture of these various monomers.

More specifically, these copolyamides may be, for example, polyhexamethylene adipamide, polyphthalamides obtained from terephthalic and/or isophthalic acid such as the polyamide sold under the trade name AMODEL, or copolyamides obtained from adipic acid, hexamethylene diamine and caprolactam.

The thermoplastic polymer may be a polyester, such as polyethylene terephthalate (PET), polypropylene terephthalate (PPT), polybutylene terephthalate (PBT), and copolymers and blends thereof.

More preferably still, the thermoplastic polymer is chosen from the group of (co)polyamides comprising: polyamide 6, polyamide 6,6, polyamide 4, polyamide 11, polyamide 12, the polyamides 4/6, 6/10, 6/12, 6/36, 12/12, and copolymers and blends thereof.

The yarns, fibres and filaments of the invention may be based on a blend of thermoplastic polymers or of thermoplastic copolymers.

The yarns, fibres or filaments of the invention are obtained from a composition comprising a novolac resin. Novolac resins are polyhydroxy compounds, for example the condensation products of phenolic compounds with aldehydes. These condensation reactions are generally catalyzed by an acid.

The phenolic compounds may be chosen, alone or as a mixture, from phenol, cresol, xylenol, naphthol, alkylphenols, such as butylphenol, tert-butylphenol or isooctylphenol; or any other substituted phenol. The most commonly used aldehyde is formaldehyde. It is possible, however, to use others, such as acetaldehyde, para-formaldehyde, butyraldehyde, crotonaldehyde and glycoxal.

According to one particular embodiment of the invention, the resin is a condensation product of phenol and of formaldehyde.

Advantageously, the novolac resin has the following formula:

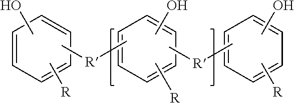

where R and R′ are alkyl groups, t is between 1 and 20, preferably between 8 and 13.

The resins used advantageously have a molecular weight of between 500 and 3000 g/mol, preferably between 800 and 2000 g/mol.

As a commercial novolac resin, mention may be made, in particular, of the products Durez®, Vulkadur® or Rhenosin®.

The composition from which the yarns, fibres or filaments of the invention are obtained comprises between 0.1 and 20% by weight, preferably between 1 and 10% by weight, of novolac resin.

The yarns, fibres, filaments of the invention may comprise additives such as reinforcing fillers, flame retardants, UV stabilizers, heat stabilizers, mattifying agents, such as titanium dioxide, bioactive agents, etc.

The overall linear density of the yarns of the invention may be chosen from throughout the range of the usual yarn linear densities, for example between 200 dtex and 3000 dtex. According to one particular embodiment of the invention, the yarns, fibres or filaments of the invention are yarns that have an overall linear density of between 700 and 2500 dtex.

The strand linear density of the yarns of the invention may be chosen from throughout the range of the usual yarn linear densities. The strand linear density is generally greater than or equal to 0.3 dtex. It is usually less than the equivalent in dtex of a diameter of 800 microns in the case of large-diameter monofilaments. According to one particular embodiment of the invention, the yarns, fibres or filaments of the invention are yarns that have a strand linear density of between 3 and 10 dtex.

The invention also relates to a process for preparing the yarns, fibres and filaments of the invention, by spinning the composition comprising the thermoplastic polymer matrix and the novolac resin.

The composition may be prepared according to any method known to a person skilled in the art.

The composition may be produced by introducing the novolac resin into the molten polymer in a mixing device, for example upstream of a spinning device. This may be, for example, an introduction into the molten stream of the matrix, or else by means of a masterbatch.

The yarns, fibres or filaments are produced according to the customary spinning techniques from a composition comprising the thermoplastic polymer matrix and the novolac resin. The spinning may be carried out immediately after the polymerization of the matrix, the latter being in the melt state. It may be carried out starting from granules containing the composition.

The yarns, fibres, filaments according to the invention may be subjected to any of the treatments that may be carried out in steps subsequent to the spinning step. In particular, they may be relaxed or drawn, textured, crimped, heated, twisted, dyed, sized, chopped, etc. These complementary operations may be carried out continuously and integrated after the spinning device or may be carried out as a batch process. The list of operations after spinning has no limiting effect.

By spinning the composition it is possible to obtain, for example, continuous multifilament yarns, short or long fibres, monofilaments, spun yarns of fibres, webs, tapes, tows, etc.

The invention also relates, as a third subject, to an article comprising the yarns, fibres and/or filaments of the invention. The article may be a rope, cable or line comprising at least some yarns, fibres and filaments described above, especially multifilament yarns. Such articles may especially be obtained from a single type of yarns, fibres or filaments or, on the other hand, from a mixture of yarns, fibres or filaments of different types. The rope, cable or line comprises, at least in part, yarns, fibres or filaments according to the invention. For a given type of yarns, fibres or filaments—for example yarns, fibres or filaments that do not contain novolac resin—yarns, fibres or filaments of different natures can be used in the rope, cable or line of the invention. The rope, cable or line advantageously comprises at least 50% by weight of yarns, fibres or filaments of the invention.

The rope, cable or line is advantageously a climbing rope. Climbing ropes undergo high mechanical stresses. Climbing ropes are generally composed of a nucleus or core of lines surrounded by a tubular braided sheath.

The core and the sheath are generally composed of yarns. There may be connections between the yarns of the core and the yarns of the sheath. In a climbing rope, the yarns, fibres, filaments of the invention are advantageously present in the core of the rope, as opposed to the sheath. In the climbing rope of the invention, advantageously at least 50% by weight of the yarns, fibres or filaments of the core are composed of the yarns, fibres or filaments of the invention. Preferably the yarns, fibres or filaments of the invention are present both in the core and in the sheath of the rope. The rope of the invention has not only a high resistance to the possible falls by the climber during its use, but also it makes it possible to dampen these falls in order to protect the climber from serious injuries resulting from the fall, in particular when using the rope under conditions with high levels of humidity.

Thus, the invention also relates to the use of the rope of the invention under conditions of relative humidity greater than or equal to 80%, preferably greater than or equal to 90%.

The invention also relates to the use of the rope of the invention in mooring or anchoring devices for boats, ships, floating landing stages, light pontoons and anchorage, navigation or location buoys.

Finally, the invention relates to the use of a novolac resin as described above in the field of climbing ropes.

The article of the invention may also be a felt for a paper-making machine. Typically these felts comprise fibres and woven monofilament fabric. The felt may be produced from a mixture of fibres of the invention and conventional fibres. The felt may also be produced from woven fabrics comprising monofilaments of the invention and from conventional monofilaments. These felts are generally used under wet conditions.

The article of the invention may also be a woven airbag fabric generally obtained from multifilaments, or a textile article.

The article of the invention may finally be a tyre-reinforcing article. These articles may, for example, be cords. They may be obtained from multifilaments or monofilaments of the invention. They may also be obtained from mixtures of monofilaments or multifilaments according to the invention and conventional monofilaments or multifilaments.

Other details or advantages of the invention will appear more clearly in light of the examples given below.

### Tests of Damping Capacity During an Impact

The EN892 standard is a specific standard that evaluates the suitability of use of climbing ropes. In this standard, the ropes are first conditioned (72 h at 65% RH) then subjected to a succession of falls under defined conditions of rope weight, height and length of the rope and waiting period between 2 falls. Several quantities are measured, including:
the impact force or maximum force experienced by the climber during the first fall, which must be below a maximum value;
the maximum elongation during the first fall, which must be below a maximum value;
the number of falls before breakage of the rope, which must be above a minimum value.

The impact force felt by the climber is, in accordance with the laws of mechanics (Force=Mass×Acceleration) a direct reflection of the acceleration experienced by the climber. To impose a maximum force therefore amounts to imposing a maximum acceleration

The underlying physical property in this test is an energy dissipation or damping property. A “good” rope must absorb the kinetic energy of the fall as rapidly as possible.

Outside of the test carried out in accordance with the EN892 standard, necessarily carried out on ropes, it is possible to characterize the energy dissipation or damping property via many other methods. For example, the evaluation of the elastic modulus G′ and of the viscous (loss) modulus G″ and of their ratio G″/G′, known as tan δ, in dynamic mechanical tests is often used to quantify this aptitude for energy dissipation. This evaluation of the ratio tan δ this time being possible on any type of material, whether it is the finished product (the rope), the individual material constituting the rope (the multifilament or the monofilament) or of any other part obtained from the same polymer formulation (an injection-moulded part, for example).

### EXAMPLES

### Examples 1 to 4

### Preparation of Polyamide 6 and Novolac Resin Compositions

The materials used were:
granules of polyamide 6 having a viscosity number of 215 ml/g, measured in formic acid at a concentration of 90% (according to the ISO 307 standard); and
pellets of phenol-formaldehyde novolac resin sold by Rhein Chemie under the reference Rhenosin® PR95.

The polyamide 6 was first dried in a vacuum oven in order to bring its water content to a value of around 500 ppm.

The polyamide 6 granules and novolac resin pellets were mixed in a Leistritz 34 co-rotating twin-screw extruder.

A conventional profile with relatively little shear was used in this extruder. The extrusion temperature was around 270 to 280° C.

The extrusion took place without any significant difficulty. The extrusion conditions were perfectly stable and, in total, 4 batches of 10 kg each of granules were produced:

TABLE 1

| Examples | Composition |
|---|---|
| Example 1 | PA-6 |
| (comparative) | |
| Example 2 | PA-6 + 3 wt % of Rhenosin ® PR 95 |
| Example 3 | PA-6 + 4 wt % of Rhenosin ® PR 95 |
| Example 4 | PA-6 + 5 wt % of Rhenosin ® PR 95 |

### Examples 5 to 8

### Spinning and Drawing of the Compositions

Multifilaments with an overall linear density of 84 dtex and that comprised 12 strands (individual linear density after drawing of around 7 dtex) were produced from the granules from Examples 1 to 4 on a Fourne laboratory spinning/drawing head.

This spinning was carried out using a single-screw extruder, a dosing pump and a spinneret, the spinning temperature was 265-270° C. and the winding rate was 300 m/min.

This spinning step took place under perfectly stable conditions. The take-up rate could be maintained without difficulties and no breakage of strands was perceptible. This shows that the phenol-formaldehyde resin is perfectly compatible with the PA-6 matrix in a spinning process.

Secondly, a subsequent drawing step was carried out, by passing over heating rollers, then relaxation and winding.

The winding was carried out at around 400 m/min.

The take-up rate of the latter rollers was adjusted in order to obtain a yarn having an elongation at break of around 20%. This corresponded to a draw ratio of 4.35.

It should be noted that the drawing of these various yarns took place under good conditions. The draw ratio of 4.35 for the reference yarns from Example 1 could be maintained at the same level over the additive systems of the yarns from Examples 2 to 4, which shows that the phenol-formaldehyde resin, added at around 5%, is compatible with a drawing process.

The following table summarizes the tensile testing analysis results. They are the average of 10 breakage values. They were measured on a Frank machine in a laboratory conditioned to textile standards (65% RH).

TABLE 2

| | | Overall | Secant | | |
|---|---|---|---|---|---|
| | | linear | modulus | Elongation | |
| | | density | E_{5%} | at break | Tenacity |
| Examples | Granules | (dtex) | (cN/tex) | (%) | (cN/tex) |
| Example 5 | Example 1 | 83.8 | 11.1 | 21.5 | 74.1 |
| (comparative) | | | | | |
| Example 6 | Example 2 | 83.8 | 11.6 | 20.5 | 71.8 |
| Example 7 | Example 3 | 83.1 | 12.0 | 20.9 | 69.3 |
| Example 8 | Example 4 | 82.8 | 11.9 | 19.7 | 68.1 |

### Examples 9 and 10

### Evaluation of the Damping Capacity of Compositions Comprising Polyamide 6 and Novolac Resin

Sheet mouldings of 100×100×1 mm were produced from the granules from Examples 1 and 4 in a Demag H200-80 press, which corresponds respectively to Examples 9 and 10. The barrel temperature was around 285 to 290° C.

The injection moulding of these 2 samples took place without any particular difficulty.

The evaluation of the damping capacity of the compositions from Example 1 and from Example 4, which corresponds respectively to Examples 9 and 10, was carried out by measuring the ratio between the viscous (loss) modulus G″ and the elastic modulus G′, known as G″/G′=tan δ. This measurement was carried out on a Rheometrics RSA2 model dynamic mechanical analysis (DMA) machine.

The DMA evaluations were carried out on test specimens cut from the preceding sheets. A sinusoidal stress applied as 3-point bending with double support (frequency 1 Hz and amplitude 0.02%) and the DMA analysis was carried out between −50 and +100° C. (rising at +2.5° C./min).

The DMA evaluations were carried out under 3 different hygrometric equilibrium conditions of the test specimens, at respective values of 50%, 75% and 95% RH. These hygrometric equilibria were obtained at the end of accelerated preconditioning, carried out at 70° C. The conditioning times needed to reach equilibrium were estimated by monitoring the water uptake. They were a minimum of 96 h at 50% RH, 48 h at 75% RH and 24 h at 95% RH.

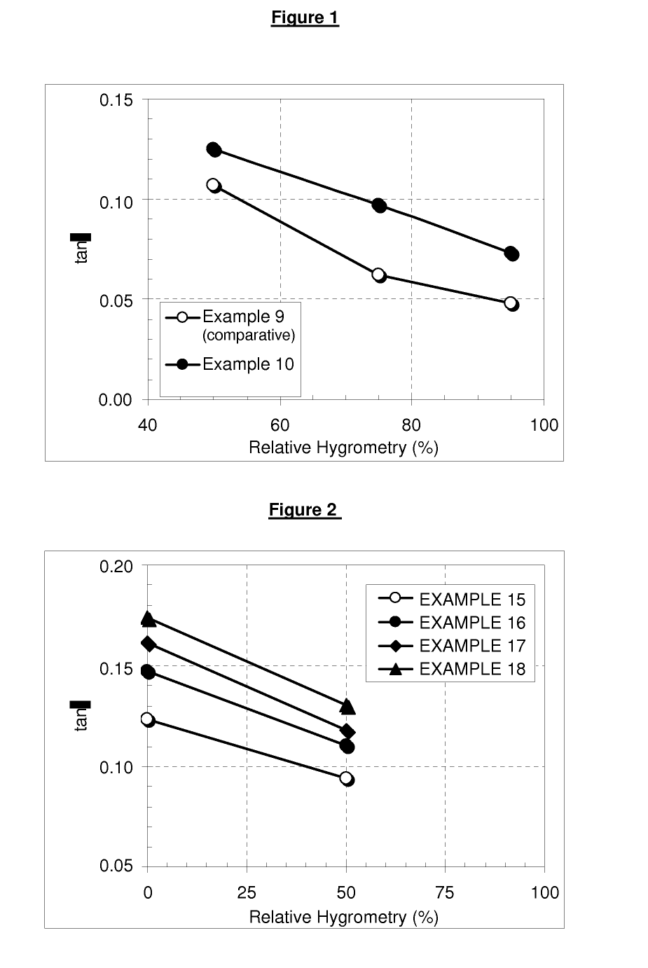

Table 3 and FIG. 1 specify the values of the dissipation coefficient tan δ, measured with this DMA method at a temperature of 25° C., corresponding to the typical stress temperature during the impact of the climbing rope.

Table 3 and FIG. 1 show that the damping capacity (the factor tan δ) is improved at 25° C. between 50 and 95% RH for the additive system according to the invention.

TABLE 3

| | Tanδ | Tanδ |
|---|---|---|
| Conditions | Example 9 | Example 10 |
| 25° C. - 50% RH | 0.107 | 0.125 |
| 25° C. - 75% RH | 0.062 | 0.097 |
| 25° C. - 95% RH | 0.048 | 0.073 |

### Examples 11 to 14

### Preparation of Polyamide 6.6 and Novolac Resin Compositions

The materials used were:
granules of polyamide 6,6 having a viscosity number of 140 ml/g, measured in formic acid at a concentration of 90% (according to the ISO 307 standard); and
pellets of phenol-formaldehyde novolac resin sold by Rhein Chemie under the reference Rhenosin® PR95.

The polyamide 6,6 was first dried in a vacuum oven in order to bring its water content to a value of around 0.1 to 0.2% by weight.

The polyamide 6,6 granules and novolac resin pellets were mixed in a Leistritz 34 co-rotating twin-screw extruder.

A conventional profile with relatively little shear was used in this extruder.

The extrusion temperature was around 280 to 295° C. depending on the zones.

The extrusion took place without any significant difficulty. The extrusion conditions were perfectly stable and, in total, 4 batches of 10 kg each of granules were produced:

TABLE 4

| Examples | Composition |
|---|---|
| Example 11 | PA-6,6 |
| (comparative) | |
| Example 12 | PA-6,6 + 4 wt % of Rhenosin ® PR 95 |
| Example 13 | PA-6,6 + 6 wt % of Rhenosin ® PR 95 |
| Example 14 | PA-6,6 + 8 wt % of Rhenosin ® PR 95 |

### Examples 15 to 18

### Evaluation of the Damping Capacity of Compositions Comprising Polyamide 6,6 and Novolac Resin

Sheet mouldings of 100×100×1 mm were produced from the granules from Examples 11 to 14 in a Demag H200-80 press, which corresponds respectively to Examples 15 to 18. The barrel temperature was around 280 to 290° C. depending on the zones.

The injection moulding of these 4 samples took place without any particular difficulty.

The evaluation of the damping capacity of these compositions was carried out under the same conditions as for the preceding Examples 9 and 10, that is to say with the DMA technique on the RSA2 machine.

The DMA evaluations were carried out under 2 different hygrometric equilibrium conditions of the test specimens, at respective values of 0% and 50% RH. The value 0% RH corresponds to withdrawing directly after exiting the press followed by conditioning under an inert atmosphere before evaluating. The hygrometric equilibrium for the value of 50% RH was obtained at the end of accelerated preconditioning, carried out at 70° C. The conditioning time needed to reach equilibrium was estimated by monitoring the water uptake. It was around 75 h at 50% RH.

Table 5 and FIG. 2 specify the values of the dissipation coefficient tan δ, measured with this DMA method at a temperature of 25° C., corresponding to the typical stress temperature during the impact of the climbing rope.

Table 5 and FIG. 2 show that the damping capacity (the factor tan δ) is improved at 25° C. between 0 and 50% RH for the additive system according to the invention.

TABLE 5

| | Tanδ | Tanδ | Tanδ | Tanδ |
|---|---|---|---|---|
| Conditions | Example 15 | Example 16 | Example 17 | Example 18 |
| 25° C. - 0% RH | 0.1234 | 0.1471 | 0.1616 | 0.1738 |
| 25° C. - 50% RH | 0.0940 | 0.1104 | 0.1180 | 0.1306 |

### Examples 19 to 21

### Spinning and Drawing of the Compositions

Multifilaments with an overall linear density of 84 dtex and that comprised 12 strands (individual linear density after drawing of around 7 dtex) were produced from the following formulations on a Fourne laboratory spinning/drawing head.

TABLE 6

| Examples | Composition |
|---|---|
| Example 19 | PA-6,6 |
| (comparative) | |
| Example 20 | PA-6,6 + 1 wt % of Rhenosin ® PR 95 |
| Example 21 | PA-6,6 + 3 wt % of Rhenosin ® PR 95 |

The PA-6,6 granules and the Rhenosin® PR95 pellets were added directly into the spinning head.

This spinning was carried out using a single-screw extruder, a dosing pump and a spinneret, the spinning temperature was 280-290° C. and the winding rate was 300 m/min.

This spinning step took place under perfectly stable conditions. The take-up rate could be maintained without difficulties and no breakage of strands was perceptible. This shows that the phenol-formaldehyde resin is perfectly compatible with the PA-6,6 matrix in a spinning process.

Secondly, a subsequent drawing step was carried out, by passing over heating rollers, then relaxation and winding.

The winding was carried out at around 400 m/min.

The take-up rate of the latter rollers was adjusted in order to obtain a yarn having an elongation at break of around 20%.

It should be noted that the drawing of these various yarns took place under good conditions. The draw ratio of the reference yarns (Example 19) was 4.76. It could be maintained at the same level over the 1% additive system (Example 20), which shows that the phenol-formaldehyde resin is compatible with a drawing process.

The following table summarizes the tensile testing analysis results. They are the average of 10 breakage values. They were measured on a Frank machine in a laboratory conditioned to textile standards (65% RH).

TABLE 7

| | Linear | Elongation | Tenacity |
|---|---|---|---|
| Examples | density (dtex) | at break (%) | (cN/tex) |
| Example 19 | 83.9 | 18.8 | 84.7 |
| (comparative) | | | |
| Example 20 | 83.4 | 19.9 | 83.3 |
| Example 21 | 81.7 | 20.1 | 78.1 |

1-17. (canceled)

18. A yard, fiber or filament having enhanced tensile strength under conditions of both low to high relative humidity and shaped from a thermoplastic polymer composition which comprises a thermoplastic polymer matrix and a novolac resin.

19. A yarn, fiber or filament as defined by claim 18, wherein said polymer matrix comprises a thermoplastic polyamide matrix.

20. A yarn, fiber or filament as defined by claim 18, wherein said novolac resin comprises a condensation product of phenol and of formaldehyde.

21. A yarn, fiber or filament as defined by claim 18, wherein said novolac resin has the following structural formula: 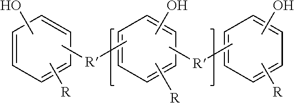
wherein R and R′ are alkyl groups and t ranges from 1 to 20.

22. A yarn, fiber or filament as defined by claim 18, wherein said thermoplastic polymer composition comprises from 0.1% to 20% by weight of novolac resin.

23. A process for preparing a yarn, fiber or filament as defined by claim 18, comprising spinning the polymer composition which comprises the thermoplastic polymer matrix and the novolac resin.

24. The process as defined by claim 23, wherein the spinning is a melt-spinning of the polymer composition.

25. A shaped article comprising a yarn, fiber or filament as defined be claim 18.

26. The shaped article as defined by claim 25, comprising a rope, cable or line.

27. The shaped article as defined by claim 26, comprising a climbing rope.

28. The shaped article as defined by claim 25, comprising a tire-reinforcing article.

29. The shaped article as defined by claim 25, comprising a woven airbag fabric.

30. The shaped article as defined by claim 25, comprising a felt for a paper-making machine.

31. The shaped article as defined by claim 25, comprising a textile.

32. An application of a shaped article as defined by claim 25, under conditions of relative humidity greater than or equal to 80%.

33. An application of a shaped article as defined by claim 25, in mooring or anchoring devices for boats, ships, floating landing stages, light pontoons and anchorage, navigation or location buoys.

34. The climbing rope as defined by claim 27, comprising either a core and/or sheath of said shaped article.

35. A yarn as defined by claim 18, having a linear density ranging from 200 to 3,000 dtex.

36. A yarn, fiber or filament as defined by claim 18, wherein said polymer matrix comprises a thermoplastic (co)polymer matrix of a polyolefin, polyester, polyalkylene oxide, polyoxyalkylene, polyhaloalkylene, poly(alkylene phthalate or terephthalate), poly(phenyl or phenylene), poly(phenylene oxide or sulphide), polyvinyl acetate, polyvinyl alcohol, polyvinyl halide, polyvinylidene halide, polyvinyl nitrile, polyimide, polycarbonate, acrylic or methacrylic acid polymer, polyacrylate or polymethacrylate, cellulose or derivative thereof, synthetic elastomer, or blend and/or alloy thereof.

37. A yarn, fiber or filament as defined by claim 18, wherein said novolac resin comprises a condensation product of a phenolic compound and of an aldehyde.
